(19) United States
(12) Patent Application Publication
(10) Pub. No.: US 2024/0154221 A1
(43) Pub. Date: May 9, 2024

(54) CYLINDRICAL BATTERY

(71) Applicant: Panasonic Energy Co., Ltd., Moriguchi-shi, Osaka (JP)

(72) Inventor: Ryota Okimoto, Osaka (JP)

(73) Assignee: Panasonic Energy Co., Ltd., Moriguchi-shi, Osaka (JP)

(21) Appl. No.: 18/279,777

(22) PCT Filed: Mar. 9, 2022
(86) PCT No.: PCT/JP2022/010197

§ 371 Date: Aug. 31, 2023

(30) Foreign Application Priority Data
Mar. 15, 2021 (JP) 2021-041027

(51) Int. Cl. H01M 50/188; H01M 10/0587; H01M 50/107; H01M 50/152; H01M 50/167; H01M 50/193; H01M 50/342

(52) U.S. Cl. CPC H01M 50/188; H01M 10/0587; H01M 50/167; H01M 50/193; H01M 50/107; H01M 50/152; H01M 50/3425

(57) ABSTRACT

Provided is a cylindrical battery in which degradation of sealing properties is suppressed. A cylindrical battery according to an embodiment of the present disclosure comprises a bottomed cylindrical exterior body, an electrode body and a nonaqueous electrolyte that are accommodated in the exterior body, and a circular sealing body that seals an opening in the exterior body with a gasket, wherein the sealing body has a protrusion that abuts the end of the gasket on the outside of the cylindrical battery.

### TECHNICAL FIELD

The present disclosure relates to a cylindrical battery.

### BACKGROUND ART

Cylindrical batteries are sealed airtightly with a sealing assembly fixed by crimping with a gasket interposed, at the opening of an exterior body having a bottomed cylindrical shape which houses an electrode assembly and a non-aqueous electrolyte. Patent Literature 1 discloses a cylindrical battery in which the edge of the opening of an exterior body is squeezed into a gasket.

### CITATION LIST

### Patent Literature

### PATENT LITERATURE 1: Japanese Unexamined Patent Application Publication No. 2000-306557

### SUMMARY

### Technical Problem

Cylindrical batteries such as secondary batteries have been extensively used in recent years, and required to be durable even under harsh use environments, such as outdoors. The present inventors have intensively studied and as a result have found that a gasket might creep and deform inwardly in the radial direction of the cylindrical battery and form a gap between an exterior body and the gasket depending on the use environment, which deteriorates sealability of the battery. The deformation of the gasket is not taken into consideration in the technique described in Patent Literature 1, and therefore there is still room for improvement in sealability of batteries.

It is an advantage of the present disclosure to provide a cylindrical battery that less readily deteriorates in sealability.

### Solution to Problem

A cylindrical battery according to one aspect of the present disclosure comprises: an exterior body of a bottomed cylindrical shape; an electrode assembly and a non-aqueous electrolyte that are accommodated in the exterior body; and a circular sealing assembly that seals an opening of the exterior body with a gasket interposed, wherein the sealing assembly has a protrusion that abuts an end of the gasket on the exterior side of the cylindrical battery.

### Advantageous Effect of Invention

According to one aspect of the present disclosure, sealability of the cylindrical battery is less readily degraded.

### BRIEF DESCRIPTION OF DRAWING

FIG. 1 is a longitudinal sectional view of a cylindrical battery according to one embodiment.

FIG. 2 is an enlarged view of the cylindrical battery according to one embodiment in the vicinity of an opening of an exterior body after a certain period of storage.

FIG. 3A is a plan view of a sealing assembly according to one embodiment.

FIG. 3B is a sectional view along line A-A of FIG. 3A.

FIG. 4 is a view of another embodiment corresponding to FIG. 3A.

FIG. 5 is a view of a cylindrical battery related to a conventional art, corresponding to FIG. 2.

### DESCRIPTION OF EMBODIMENTS

Exemplary embodiments of a cylindrical battery according to the present disclosure are described in detail below with reference to the drawings. In the description below, specific shapes, materials, numeral values, directions and so on are provided for the purpose of exemplification in order to facilitate understanding of the present invention, and can be changed as necessary in conformity with specifications of the cylindrical battery. In the case where the description below includes a plurality of embodiments and modifications, it is preliminary assumed that features of such embodiments and modifications may be properly combined.

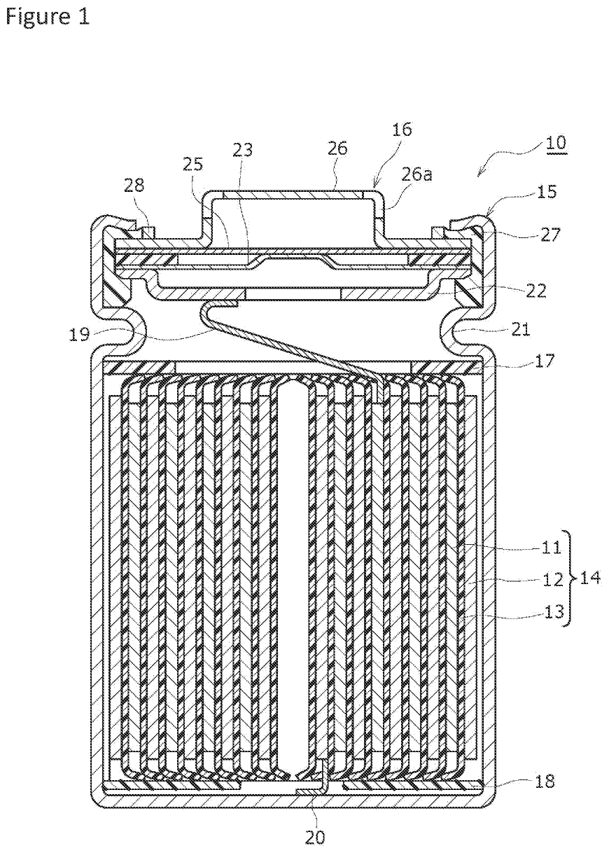

FIG. 1 is a longitudinal sectional view of a cylindrical battery 10 according to an exemplary embodiment. The cylindrical battery 10 shown in FIG. 1 has an electrode assembly 14 and a non-aqueous electrolyte (not shown) which are housed in an exterior body 15. In the description below, the side of a sealing assembly 16 is referred to as the “upper side” and the bottom side of the exterior body 15 as the “lower side” for the sake of convenience of description.

The electrode assembly 14 has a wound structure in which a positive electrode 11 and a negative electrode 12 are wound together with a separator 13 interposed therebetween. The positive electrode 11 has a strip-shaped positive electrode current collector and a positive electrode compound layer provided on both sides of the positive electrode current collector. Examples of the positive electrode current collector include metal (e.g., aluminum) foil, film provided with the metal foil as a surface layer, or the like.

The positive electrode compound layer is produced by, for example, coating both sides of the positive electrode current collector with positive electrode compound slurry containing a positive electrode active material, a conductive agent, a binding agent, and a solvent such as N-methyl-2-pyrrolidone (NMP), followed by drying and rolling. Examples of the positive electrode active material include a lithium-transition metal complex oxide containing a transition metal element such as Co, Mn, or Ni. Examples of the conductive agent include carbon materials such as carbon black (CB), acetylene black (AB), Ketjenblack, and graphite. Examples of the binding agent include fluorocarbon resins such as polytetrafluoroethylene (PTFE) and polyvinylidene fluoride (PVdF); polyacrylonitrile (PAN); polyimide (PI); acrylic resins; and polyolefin resins.

The negative electrode 12 has a strip-shaped negative electrode current collector and a negative electrode compound layer provided on both sides of the negative electrode current collector. Examples of the negative electrode current collector include metal (e.g., copper) foil, film provided with the metal foil as a surface layer, or the like.

The negative electrode compound layer is produced by, for example, coating both sides of the negative electrode current collector with negative electrode compound slurry containing a negative electrode active material, a binding agent, and water or the like, followed by drying and rolling. Examples of the negative electrode active material include carbon materials such as natural graphite, artificial graphite, graphitizable carbons (soft carbons), and non-graphitizable carbons (hard carbons); metals such as Si and Sn which form an alloy with lithium; and alloys and oxides containing such a material. Examples of the binding agent include styrene-butadiene rubber (SBR), CMC or salts thereof; polyacrylic acids or salts thereof; and polyvinyl alcohols.

A porous sheet having ion permeability and insulation properties is used as the separator 13. Specific examples of the porous sheet include microporous thin films, woven fabrics, and non-woven fabrics. The material for the separator is preferably an olefin resin such as polyethylene or polypropylene.

Examples of a non-aqueous solvent (organic solvent) for the non-aqueous electrolyte housed in the exterior body 15 include carbonates, lactones, ethers, ketones, and esters, two or more of which may be mixed. In the case where two or more solvents are mixed, preferably used is a mixed solvent containing cyclic carbonate and chain carbonate. Examples of the cyclic carbonate include ethylene carbonate (EC), propylene carbonate (PC), and butylene carbonate (BC), and examples of the chain carbonate include dimethyl carbonate (DMC), ethyl methyl carbonate (EMC), and diethyl carbonate (DEC). Examples of an electrolyte salt for the non-aqueous electrolyte include LiPF₆, LiBF₄, LiCF₃SO₃ and the like, and a mixture thereof. The amount of dissolution of the electrolyte salt in the non-aqueous solvent may be 0.5 to 2.0 mol/L, for example.

The opening of the exterior body 15 is sealed with the sealing assembly 16 with the gasket 27 interposed, thereby the interior of the cylindrical battery 10 is sealed airtightly. The electrode assembly 14 is provided with insulating plates 17 and 18 on the upper and lower sides, respectively. A positive electrode lead 19 extends upward through a through hole of the insulating plate 17 and is welded to the lower surface of a filter 22 that serves as a bottom plate of the sealing assembly 16. In the cylindrical battery 10, a cap 26 serving as a top plate of the sealing assembly 16 electrically connected to the filter 22 comprises a positive electrode terminal. The negative electrode lead 20 extends through a through hole of the insulating plate 18 toward the bottom side of the exterior body 15, and is welded to the bottom inner surface of the exterior body 15. In the cylindrical battery 10, the exterior body 15 comprises a negative electrode terminal.

The exterior body 15 has a bottomed cylindrical shape and is made of metal, preferably. The exterior body 15 has a grooved portion 21, which is formed by pressing the side wall from the outside, for example. The grooved portion 21 is preferably annularly provided along the circumferential direction of the exterior body 15. The sealing assembly 16 is fixed between the grooved portion 21 and the open edge of the exterior body 15, which is curved inwardly, with the gasket 27 interposed. The gasket 27 is a flexible insulating member and electrically isolates the sealing assembly 16, which is the positive electrode terminal, and the exterior body 15, which is the negative electrode terminal, from each other. The gasket 27 is compressed in the vertical direction, thereby airtightly sealing the interior of the cylindrical battery 10. Any compressible insulating material can be used as the gasket 27, including polypropylene (PP), polyphenylene sulfide (PPS), polyethylene (PE), polybutylene terephthalate (PBT), perfluoroalkoxy alkane (PFA), polytetrafluoroethylene (PTFE), polyamide (PA), and the like.

The sealing assembly 16 is circular, and has the filter 22, a lower vent member 23, an insulating member 24, an upper vent member 25, and the cap 26 layered in order from the side of the electrode assembly 14. The members composing the sealing assembly 16 each have a disk shape or ring shape, for example, and are electrically connected to each other, except for the insulating member 24. The lower vent member 23 and the upper vent member 25 are connected at the center portion of each, and are provided with the insulating member 24 interposed therebetween at the peripheral portion of each. In case that internal pressure of the battery increases due to abnormal heat generation, the lower vent member 23 breaks, allowing the upper vent member 25 to swell toward the cap 26 and separate from the lower vent member 23, thereby interrupting electrical connection therebetween, for example. If the internal pressure further increases, the upper vent member 25 breaks, so that gas is released through an opening hole 26a of the cap 26. The upper surface of the cap 26 is provided with a protrusion 28 that abuts the end of the gasket 27, as described later. That is, the sealing assembly 16 is provided with the protrusion 28 that abuts the end of the gasket 27, on the exterior side of the cylindrical battery 10.

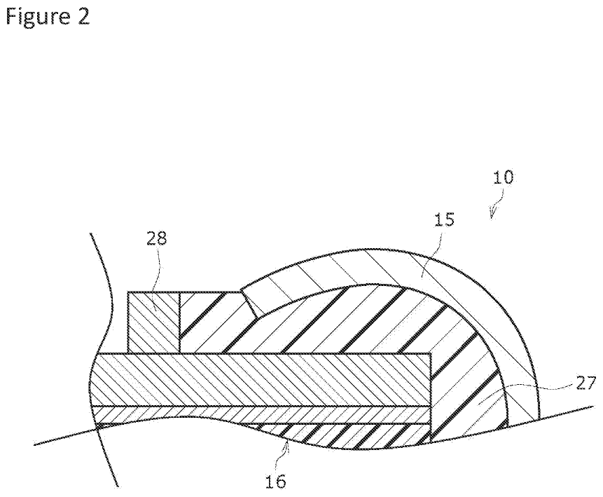

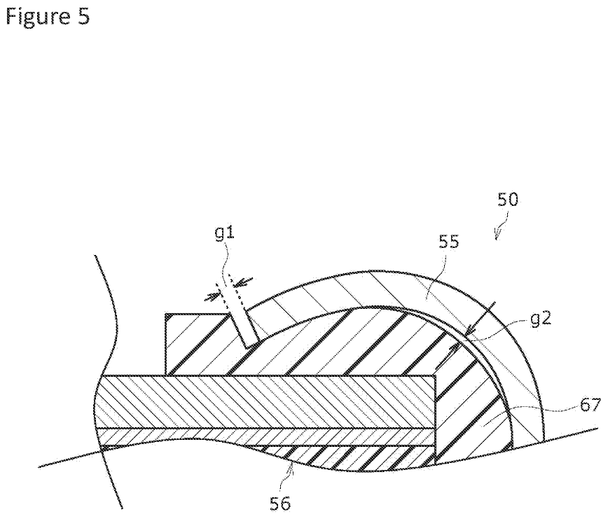

Next, the difference between the cylindrical battery 10 according to one embodiment and a conventional cylindrical battery 50 will be described with reference to FIGS. 2 and 5. FIG. 2 is an enlarged view of the cylindrical battery 10 according to one embodiment in the vicinity of the opening of the exterior body 15 after a certain period of storage. FIG. 6 is a view of the conventional cylindrical battery 50 corresponding to FIG. 2.

According to the conventional cylindrical battery 50 shown in FIG. 5, a certain period of storage causes a gasket 67 to creep and deform inwardly in the radial direction of the cylindrical battery 10 and form a gap between the exterior body 55 and the gasket 67. The gap between the exterior body 55 and the gasket 67 deteriorates the sealability of the cylindrical battery 10. Examples of the gap between the exterior body 55 and the gasket 67 include a gap g1 between the end of the exterior body 55 and the gasket 67 and a gap g2 between the exterior body 55 and the gasket 67 inside the curved portion of the exterior body 55.

In the cylindrical battery 10 according to one embodiment shown in FIG. 2, the end of the gasket 27 is abutted the protrusion 28, because of which the protrusion 28 prevents creep-deformation of the gasket 27. This prevents the exterior body 15 and the gasket 27 from forming a gap between them, preventing deterioration in sealability of the cylindrical battery 10. The protrusion 28 may have any sectional shape which prevents movement of the gasket 27, including a rectangle shape as shown in FIG. 2. The protrusion 28 may have any height and width which prevent movement of the gasket 27, and may be 0.1 mm to 1 mm high and 0.1 mm to 1 mm wide. The width of the protrusion 28 may be 0.3 to 1 time the height of the protrusion 28. The height of the protrusion 28 may be 0.5 to 2 times the thickness of the gasket 27. The protrusion 28 may be made of any material, preferably the same material as that of the cap 26. With this, the protrusion 28 can be molded integrally with the cap 26. The protrusion 28 may be adhered to the cap 26.

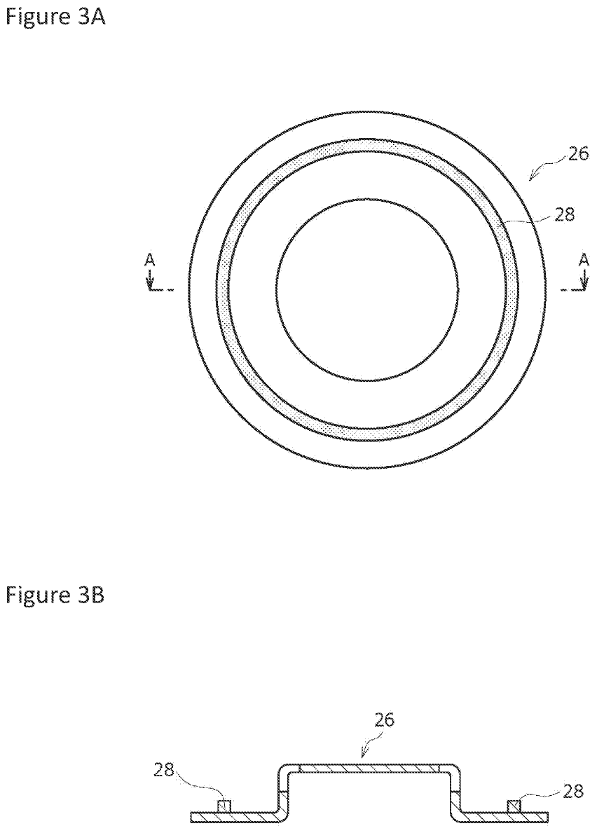

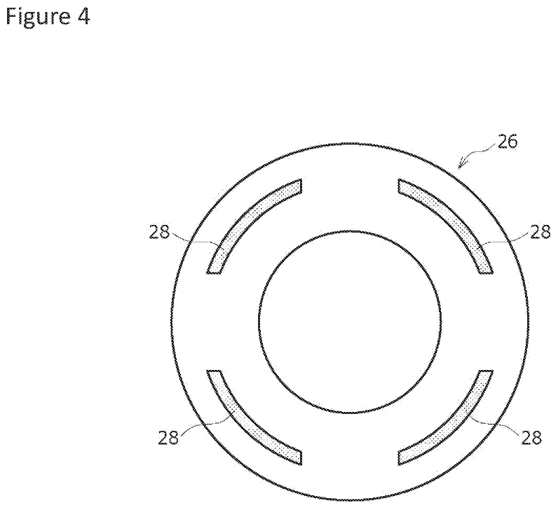

Next, the protrusion 28 will be described with reference to FIG. 3A, FIG. 3B, and FIG. 4. FIG. 3A is a plan view of the sealing assembly according to one embodiment, and FIG. 3B is a sectional view along line A-A of FIG. 3A. FIG. 4 is a view of another embodiment corresponding to FIG. 3A.

As shown in FIG. 3A and FIG. 3B, the protrusion 28 is continuously provided in concentric with the circumference of the sealing assembly 16 (cap 26). Protrusions 28 may be intermittently provided in concentric with the circumference of the sealing assembly 16 (cap 26), as shown in FIG. 4.

In the case where the protrusions 28 are intermittently disposed, the number of protrusions 28 and place of disposition thereof are not limited. From the view point of sealability of the cylindrical battery 10, the total length of protrusions 28 corresponds to preferably 30% or more, and more preferably 45% or more of the circumferential length of a circle formed by connecting neighboring protrusions 28. From the view point of sealability of the cylindrical battery 10, the protrusions 28 are preferably disposed at equal intervals in concentric with the circumference of the sealing assembly 16 (cap 26).

### EXAMPLES

Although the present disclosure will be further described below by way of Examples, the present disclosure is not limited thereto.

### Example 1

[Production of Positive Electrode]

A lithium-transition metal complex oxide represented by LiNi_{0.8}Co_{0.15}Al_{0.05}O₂ was used as a positive electrode active material. 100 pts·mass of the positive electrode active material, 2.5 pts·mass of acetylene black (AB) as a conductive agent, and 1.7 pts·mass of polyvinylidene fluoride (PVdF) as a binding agent were mixed, and an appropriate amount of N-methyl-2-pyrrolidone (NMP) was added thereto, thereby preparing positive electrode compound slurry. Next, the positive electrode compound slurry was applied on both sides of a positive electrode current collector made of aluminum foil and dried with a dryer, following which the resulting material was cut into a predetermined size of electrode, and rolled with a roller, thereby obtaining a strip-shaped positive electrode. One end of the positive electrode in the longitudinal direction was provided with no active material to serve as a plain portion, and a positive electrode lead made of aluminum was ultrasonically welded to the plain portion.

[Production of Negative Electrode]

A graphitizable carbon was used as a negative electrode active material. 100 pts·mass of the negative electrode active material, 0.6 pt·mass of styrene-butadiene rubber (SBR) as a binding agent, and 1 pt·mass of carboxy methyl cellulose (CMC) as a thickening agent were mixed, and an appropriate amount of water was added thereto, thereby preparing negative electrode compound slurry. Next, the negative electrode compound slurry was applied on both sides of a negative electrode current collector made of copper foil and dried with a dryer, following which the resulting material was cut into a predetermined size of electrode, and rolled with a roller, thereby obtaining a strip-shaped positive electrode. One end of the negative electrode in the longitudinal direction was provided with no active material to serve as a plain portion, and a negative electrode lead made of Ni—Cu—Ni clad material was ultrasonically welded to the plain portion.

[Preparation of Sealing Assembly]

A sealing assembly was prepared which had a filter, a lower vent member, an insulating member, an upper vent member, and a cap layered in order. The outer diameter of the cap was φ17 mm. A protrusion 0.2 mm wide and 0.4 mm high was disposed on the upper surface of the cap 1.5 mm inside and in concentric with the circumference of the cap.

[Preparation of Non-Aqueous Electrolyte]

To a mixed solvent containing ethylene carbonate (EC), ethyl methyl carbonate (EMC), and diethyl carbonate (DEC) at a volume ratio of EC:EMC:DMC=3:3:4 was added 1.0 mol/L of LiPF₆, thereby preparing a non-aqueous electrolyte.

[Preparation of Cylindrical Battery]

The positive electrode and negative electrode were spirally wound with a separator made of polyolefin resin interposed, thereby preparing a wound electrode assembly. The electrode assembly was housed in a metal exterior body of a bottomed cylindrical shape with an insulating plate inserted under the electrode assembly, and the negative electrode lead was welded to the bottom of the exterior body. After an insulating plate was inserted above the electrode assembly, a grooved portion was formed by pressing on an opening of the exterior body, and a non-aqueous electrolyte was poured into the inside of the exterior body. A gasket was housed above the grooved portion and the sealing assembly was welded to the positive electrode lead, following which the opening of the exterior body was sealed by crimping the sealing assembly with the gasket interposed, thereby preparing a cylindrical battery.

### Example 2

A battery was produced in a manner similar to that of Example 1, except that a cap used in preparation of a sealing assembly included intermittently-disposed protrusions each having a length of 5 mm, 1.5 mm inside the circumference. The cap used in Example 2 was the same as that shown in FIG. 4, and the protrusions were disposed at equal intervals in concentric with the circumference of the cap. The total length of protrusions corresponded to 45% of the circumferential length of a circle formed by connecting neighboring protrusions.

### Comparative Example

A battery was produced in a manner similar to that of Example 1, except that a cap provided with no protrusion was used in preparation of a sealing assembly.

[Evaluation of Gap Quantity Between Exterior Body and Gasket]

Batteries of Examples and Comparative Example were subjected to heat shock test including 40 cycles, each cycle comprising a process in which the battery was maintained at −40° C. for 30 minutes and thereafter at 80° C. for 30 minutes. The crimped portion above the grooved portion was cut out from the battery after the heat shock test and embedded in an epoxy resin, followed by cutting and polishing, so that the sectional view as shown in FIG. 2 was observed. After that, an optical microscope was used to determine a maximum value of gap (g1) between the end of the exterior body and the gasket, and a maximum value of gap (g2) between the inside of the curved portion of the exterior body and the gasket. The average of the maximum values of g1 and g2 was taken as a gap quantity.

Evaluation results regarding Examples and Comparative Example are shown in Table 1. Table 1 also shows the disposition method, height, and width of protrusion(s).

TABLE 1

| | Protrusion | | | |
|---|---|---|---|---|
| | Disposition | | | |
| | method | Height | Width | Gap quantity |
| Example 1 | Continuous | 0.4 mm | 0.2 mm | 0.053 mm |
| Example 2 | Intermittent | 0.4 mm | 0.2 mm | 0.057 mm |
| Comparative | — | — | — | 0.152 mm |
| example | | | | |

In Examples 1 and 2, the gap was less readily generated in the heat shock test in comparison to Comparative Example. It seems to be attributable to the protrusions preventing creep-deformation of the gasket.

### REFERENCE SIGNS LIST

10 cylindrical battery, 11 positive electrode, 12 negative electrode, 13 separator, 14 electrode assembly, 15 exterior body, 16 sealing assembly, 17, 18 insulating plate, 19 positive electrode lead, 20 negative electrode lead, 21 grooved portion, 22 filter, 23 lower vent member, 24 insulating member, 25 upper vent member, 26 cap, 26a opening hole, 27 gasket, 28 protrusion

1. A cylindrical battery, comprising:
an exterior body of a bottomed cylindrical shape;
an electrode assembly and a non-aqueous electrolyte that are accommodated in the exterior body; and
a circular sealing assembly that seals an opening of the exterior body with a gasket interposed, wherein
the sealing assembly has a protrusion that abuts an end of the gasket on an exterior side of the cylindrical battery.

2. The cylindrical battery according to claim 1, wherein the protrusion is continuously or intermittently provided in concentric with a circumference of the sealing assembly.
